(19) United States
(12) Patent Application Publication
(10) Pub. No.: US 2013/0195331 A1
(43) Pub. Date: Aug. 1, 2013

(54) APPARATUS FOR SHARING AND MANAGING INFORMATION IN PICTURE ARCHIVING COMMUNICATION SYSTEM AND METHOD THEREOF

(71) Applicant: Infinitt Healthcare Co., Ltd., Seoul (KR)

(72) Inventors: Jae Youn Yi, Seoul (KR); Tae Hyun Kim, Seoul (KR)

(73) Assignee: INFINITT HEALTHCARE CO., LTD., Seoul (KR)

(21) Appl. No.: 13/756,061

(22) Filed: Jan. 31, 2013

(30) Foreign Application Priority Data
Jan. 31, 2012 (KR) 10-2012-0009507

(51) Int. Cl. G06K 9/80

(52) U.S. Cl. CPC G06K 9/80
USPC 382/128

(57) ABSTRACT

Disclosed are an apparatus and method for sharing and managing information in a PACS. A system for storing and managing medical image includes a pre-processing unit for generating a second medical image set by using at least part of a first medical image set and a medical image storage unit for storing the first medical image set and the generated second medical image set and store first information, stored in relation to any one of the first medical image set and the second medical image set, in relation to the other of the first medical image set and the second medical image set. Although thin-slice data is deleted, annotation or marking for 3-D data can be maintained and managed.

### CROSS REFERENCE TO RELATED APPLICATION

This application claims the benefit of Korean Patent Application No. 10-2012-0009507, filed Jan. 31, 2012, which is incorporated herein by reference.

### TECHNICAL FILED

The present invention relates to the storage and management of medical image and, more particularly, to an apparatus and method for sharing and managing information in a

Picture Archiving Communication System (PACS), wherein annotation or marking for 3-D data of thin-slice data, for example, a medical image for two-dimensional (2-D) display, can be shared with thick-slice data, for example, a medical image for two-dimensional (2-D) display, through coordinate cooperation between the thin-slice data and the thick-slice data.

### BACKGROUND ART

In general, in medical behaviors that treat the life of a patient, a clinical diagnosis is a big part in treating the patient, the development of medical technology helps a precise clinical diagnosis a lot, and it is expected that dependency on the development of medical technology in the future will be further increased.

Modality or medical imaging apparatus, such as Computer Tomography (CT) and Magnetic Resonance Imaging (MRI), have become essential equipment in the modern medical science. However, in medical service, an abnormal part of a patient is photographed by the modality, and captured image is printed in the form of a film and transferred to the physician in charge of the patient. Accordingly, since a lot of time and human power are necessary in reaching a final clinical diagnosis, resources are inefficiently managed, the finances of a hospital become poor, and above all a patient cannot receive rapid and precise treatment.

Furthermore, in Korea, it is a rule that an X-ray film must be obligatorily stored for 5 years. In a hospital, X-ray films are classified and stored according to patients. However, as the size of a hospital is increased and the number of patients is increased, the number of X-ray films to be stored is also increased. As a result, there are severe problems, such as the waste of spaces and human power according to the storage and management of the X-ray films, for example, defective films having a poor storage state, re-photographing due to the loss of films, medical disputes due to the loss of films, and the waste of time and human power taken to search for a stored film.

Meanwhile, with the development of computer and communication technologies, systems for providing medical service by using computers and data communication technology have been researched and developed in the medical world in which the life of a patient is handled. For example, a Picture Archiving Communication System (hereinafter referred to as a ‘PACS’) in which a computer communication network is installed in the entire hospital, all X-ray films are converted into digital data, databased, and stored in a large-scale storage medium connected to a server, and an X-ray image of a desired patient can be queried through a computer monitor in each examination room, if necessary, has recently been introduced.

The PACS refers to a comprehensive digital image management system and transmission system for acquiring medical images, particularly, radiological diagnosis images in a digital form, storing the medical images in the form of digital data instead of the past X-ray films, and transmitting the medical images over a high-speed communication network so that radiologists and clinicians can treat patients by using an image query apparatus instead of the existing film view box.

The final aim of the PACS is to construct a filmless hospital system. To this end, technologies, such as image display and processing, data communication and networking, a database, information management, a user interface, and data storage and management, should be comprehensively constructed.

In communication in this PACS, a Digital Imaging and Communications in Medicine (DICOM) protocol is used as a standard. The DICOM protocol means not only CT and MRI, but also a variety of digital image acquisition devices, such as a nuclear medicine and ultrasonic waves, and a communication protocol for effectively supporting communication between different information systems using industry standard networks. The DICOM protocol was started being jointly standardized by American College of Radiology—ACR and National Electrical Manufacturers Association—NEMA in 1984, and a first standard for the DICOM protocol was established in 1985.

Thereafter, the DICOM protocol was revised twice in 1988 and 1993 and is now called Digital Imaging and Communications in Medicine (DICOM) of a current 3.0 version.

The DICOM protocol comes out because the modalities are frequently used in association with each other rather than being used independently. And because the medical industry is being information-oriented, agreements are needed in exchanging medical images and related information between varied modalities.

That is, in the past, manufacturers differently stored information depending on the type of modality and the model of modality without a specific standard and transmitted the information. Accordingly, expensive gateways had to be purchased in order to exchange information between modalities or information could not be exchanged.

As the DICOM standard is settled, however, modalities that comply with the standard can exchange information without a special gateway irrespective of a manufacturer and the type of modality. This means that not only communication between modalities that support the DICOM within a hospital, but also communication with remote places is possible.

Furthermore, since a network configuration method also complies with a standard method now widely used in the computer field, the DICOM standard can be easily applied to all medical image-related systems including a connection within a hospital, communication between remote clinics, and remote diagnosis systems.

As the number of images captured by modality is increased as described above, a PACS system to which the DICOM standard has been applied additionally includes a first PACS for storing medical images (i.e., thick-slices) mainly used for a 2-D display and a second PACS for storing medical images (i.e., thin-slices) mainly used for a 3-D display.

The medical images for 2-D stored in the first PACS are mainly used by clinicians, and the medical images for 3-D stored in the second PACS are mainly used by radiologists. A radiologist reconfigures medical images in 3-D, inputs annotation or marking for the medical images, and stores the annotation or marking in the second PACS along with the medical images.

The second PACS periodically deletes stored 3-D data due to a problem, such as a storage space, and thus a user has to additionally manage data necessary for researches by using an external hard disk. It is difficult to manage and search for the backup data stored in the external medium, and there is a problem in that a backup to an external media may violate Act on the Protection of Personal Information.

Furthermore, annotation or marking inputted and stored along with 3-D data is not retrieved when searching for 2-D data corresponding to 3-D data that is stored in the first PACS. Accordingly, there is a problem in that the annotation or marking is also deleted when the 3-D data is deleted.

Accordingly, there is a need for a method of checking annotation or marking for 3-D medical image data through 2-D medical image data although the 3-D medical image data is deleted.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

Accordingly, the present invention has been made keeping in mind the above problems occurring in the prior art, and an object of the present invention is to provide an apparatus and method for sharing and managing information in a PACS, which are capable of maintaining and managing annotation or marking for 3-D data by managing information on annotation or marking stored together with thin-slice data so that the information on annotation or marking is shared with thick-slice data corresponding to the thin-slice data, although the thin-slice data is deleted.

Another object of the present invention is to provide an apparatus and method for sharing and managing information in a PACS, which are capable of maintaining inputted annotation or marking in thick-slice data although thin-slice data is deleted by displaying (or storing) the annotation or marking in the thick-slice data having information on coordinates corresponding to information on the coordinates of the thin-slice data when the annotation or marking is inputted and stored together with the thin-slice data and thus checking the annotation or marking through the thick-slice data.

Yet another object of the present invention is to provide an apparatus and method for sharing and managing information in a PACS, which are capable of easily managing medical image data without a need to configure two PACS by managing thin-slice data and thick-slice data using one PACS.

In order to achieve the above objects, a system for storing and managing medical image in accordance with an embodiment of the present invention includes a pre-processing unit configured to generate a second medical image set by using at least part of a first medical image set and a medical image storage unit configured to store the first medical image set and the generated second medical image set and store first information, stored in relation to any one of the first medical image set and the second medical image set, in relation to the other of the first medical image set and the second medical image set.

The medical image storage unit may share the first information by using information on the coordinates of each of first slices included in the first medical image set and information on the coordinates of each of second slices included in the second medical image set.

Each of the first slices and the second slices may include information on reference coordinates previously set in a medical imaging equipment for capturing an original image of the first medical image set, and the medical image storage unit may share the first information by using information on the reference coordinates included in each of the first slices and the second slices.

Each of the first slices and the second slices may include information on relative coordinates corresponding to reference coordinates previously set in relation to a human body, and the medical image storage unit may share the first information by using information on the relative coordinates included in each of the first slices and the second slices.

The medical image storage unit may include first storage means for storing the first medical image set and second storage means for storing the second medical image set, and the medical image storage unit may permit access to at least one or more of the first storage means and the second storage means based on the role of a user who requests a medical image.

The medical image storage unit may determine whether the first information will be open or not based on the setting of a user who inputs the first information.

The medical image storage unit may determine whether a third medical image generated using the first medical image set or the second medical image set, the first medical image set, or the second medical image will be open or not based on the setting of a user.

An apparatus for storing and managing a medical image in accordance with another embodiment of the present invention includes first storage means for storing a first medical image set, second storage means for storing a second medical image set generated from an original image set identical with the first medical image set, and a data management unit for storing first information, stored in relation to one of the first medical image set and the second medical image set, in relation to the other of the first medical image set and the second medical image set.

The second storage means may store the second medical image set generated using at least part of the first medical image set.

The apparatus may further include an access management unit for managing access to at least one or more of the first storage means and the second storage means based on a role of a user who requests the medical image.

A method of storing and managing a medical image in accordance with yet another embodiment of the present invention includes a first storage step of storing a first medical image set, a generation step of generating a second medical image set by using at least part of the stored first medical image set, a second storage step of storing the generated second medical image set, and a third storage step of storing the first information, stored in relation to one of the first medical image set and the second medical image set, in relation to the other of the first medical image set and the second medical image set.

### BRIEF DESCRIPTION OF THE DRAWINGS

FIG. 1 shows the the configuration of a system for storing and managing medical image in accordance with an embodiment of the present invention;

FIG. 2 shows the configuration of an embodiment of a the PACS unit shown in FIG. 1;

FIG. 3 shows an embodiment of a case where information on coordinates is stored in the DICOM header of medical image slices;

FIG. 4 shows an embodiment of a method of an APS unit generating thick-slice data;

FIG. 5 is a flowchart illustrating a method of storing and managing medical image in accordance with an embodiment of the present invention;

FIG. 6 is a flowchart illustrating a process of providing a medical image to a user in the method of storing and managing medical image in accordance with the present invention; and

FIG. 7 is a flowchart illustrating an embodiment of a step S660 in FIG. 6.

### DETAILED DESCRIPTION OF THE DISCLOSURE

In addition to the above objects, other objects and characteristics of the present invention will become evident from the following description in conjunction with the accompanying drawings.

Hereinafter, some exemplary embodiments of the present invention are described in detail with reference to the accompanying drawings. In describing the embodiments of the present invention, a detailed description of the known functions and constructions will be omitted if it is deemed to make the gist of the present invention unnecessarily vague.

It should be noted that the present invention is not restricted or limited by the embodiments. The same reference numerals designate the same elements throughout the drawings.

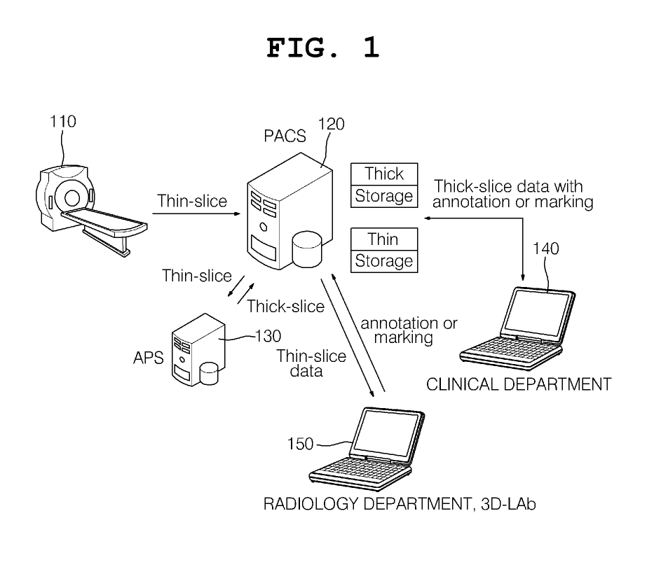

An apparatus and method for sharing and managing information in a PACS in accordance with embodiments of the present invention is described in detail below with reference to FIGS. 1 to 7.

FIG. 1 shows the configuration of a system for storing and managing medical image in accordance with an embodiment of the present invention.

Referring to FIG. 1, the system for storing and managing medical image includes a medical imaging equipment 110, a medical image storage unit (PACS) 120, a pre-processing (APS) unit 130, and client terminals 140 and 150.

The medical imaging equipment 110, that is modality or medical imaging apparatus, for example, a CT apparatus or an MRI apparatus captures a medical image of an examinee and provides medical image data for the captured medical image. The medical imaging equipment 110 provides the medical image storage unit 120 with thin-slice data generated from the captured original image.

The thin-slice data is a set of the image data generated from the original image captured by the medical imaging equipment 110. In general, the thin-slice data is a set of medical image slices reconfigured at intervals of about 0.3-1 mm, and data for detailed reading can be obtained from the thin-slice data.

The medical image storage unit 120 receives the thin-slice data from the medical imaging equipment 110, stores the received thin-slice data, and provides the received thin-slice data to the APS unit 130. Furthermore, the medical image storage unit 120 receives thick-slice data corresponding to the thin-slice data from the APS unit 130 and stores the received thick-slice data.

In general, the thick-slice data is a set of medical image slices reconfigured at intervals of about 3-5 mm and can be easily stored and maintained.

The medical image storage unit 120 can further include storage for storing thin-slice data and storage for storing thick-slice data. The storage for storing thin-slice data can be periodically deleted by the medical image storage unit 120 at a specific interval.

Furthermore, the medical image storage unit 120 enables information (hereinafter referred to as ‘first information’), such as annotation or marking between thin-slice data and thick-slice data generated from an original image, to be shared and stored between the thin-slice data and the thick-slice data. Accordingly, although thin-slice data in which first information is marked is deleted, the first information can be checked by using thick-slice data even after the thin-slice data is deleted because the first information is displayed or stored in the thick-slice data.

Here, the medical image storage unit 120 can share and store the first information between the thin-slice data and the thick-slice data by using information on the coordinates of each of medical image slices that form the thin-slice data and the thick-slice data.

Furthermore, the information on the coordinates of each of the medical image slices may be information on reference coordinates previously set in the medical imaging equipment 110 when a medical image of an examinee is captured by the medical imaging equipment 110, or may be information on relative coordinates calculated using the reference coordinates of human body that have been previously set and stored in the medical image storage unit 120. The coordinate information can be previously set in relation to the thin-slice data, and information on the coordinates of the thick-slice data can be determined using the thin-slice data.

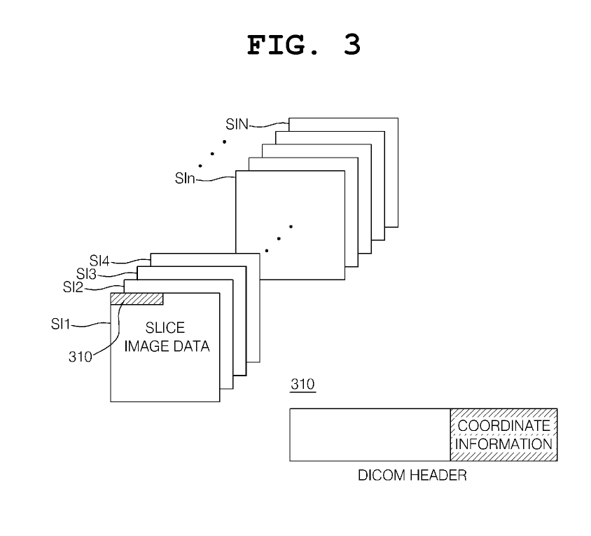

As shown in an embodiment of FIG. 3, information on the coordinates of a medical image slice can be inserted into and stored in the DICOM header 310 of the medical image slice. The medical image storage unit 120 can check a corresponding slice between thin-slice data and thick-slice data by using coordinate information stored in a DICOM header and share and store first information between the slices.

In some cases, if some of medical image slices store information on the coordinates, the medical image storage unit 120 may calculate information on the coordinates of the remaining medical image slices by using information on the coordinates of some of medical image slices and add and store information on the coordinates of the remaining medical image slices in the DICOM headers of the remaining medical image slices.

Furthermore, when a user who belongs to a clinical department and a user who belongs to a radiology department or a 3-D laboratory access the medical image storage unit 120, the medical image storage unit 120 can control access to thin-slice data and thick-slice data on the basis of the role of a user.

For example, when a clinical department user (e.g., a clinician) accesses the medical image storage unit 120 by using the client terminal 140, the medical image storage unit 120 can determine that the clinician uses thick-slice data and permit only access to the storage in which the thick-slice data is stored. When a radiology department user (e.g., a radiologist) accesses the medical image storage unit 120 by using the client terminal 150, the medical image storage unit 120 can determine that the radiologist uses thin-slice data and permit only access to the storage in which the thin-slice data is stored.

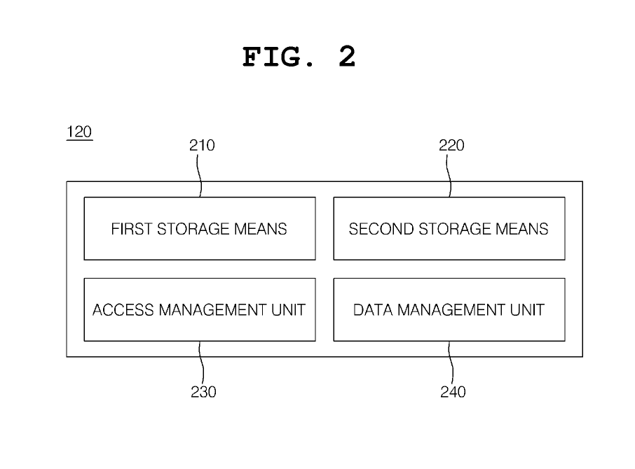

In addition, if a radiologist or a clinician sets whether first information or a 3-D data captured image will be open or not by using a hanging protocol in a client terminal, it not can be differently provided to a user based on set information on whether first information or a medical image such as a 3-D data captured image, will be open or not. This is described in detail with reference to FIG. 2.

The APS unit 130 receives thin-slice data from the medical image storage unit 120 and generates thick-slice data by using the received thin-slice data.

Here, the APS unit 130 may generate the thick-slice data by using at least part or all of medical image slices that form the thin-slice data, may select some of the thin-slice data as the thick-slice data. In some embodiments, the APS unit 130 may generate the thick-slice data by a processing process using the mean value or an interpolation scheme using the thin-slice data. The APS unit 130 may generate the thick-slice data from the thin-slice data by using one or more of similar methods or methods of generating slice data.

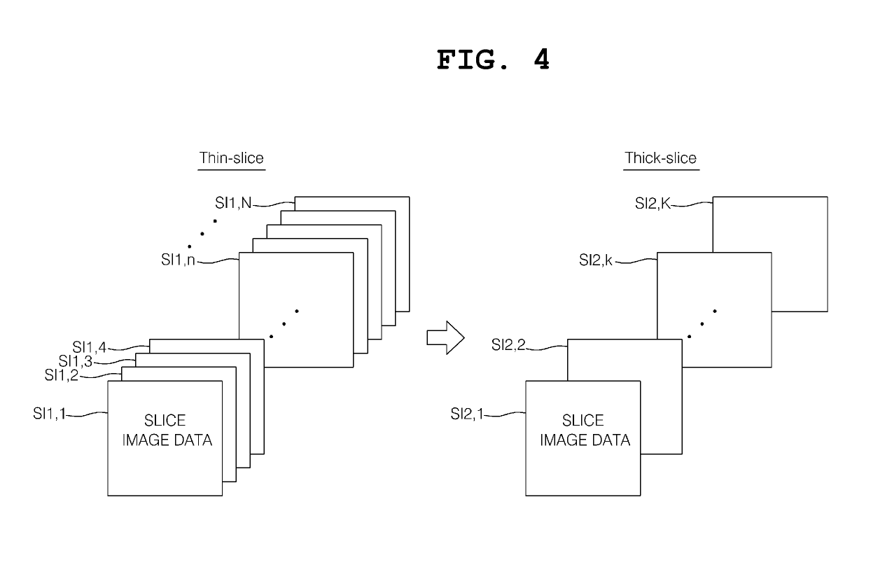

For example, as shown in an embodiment of FIG. 4, the APS unit 130 can generate K(K<N) thick-slice data, that is, medical image slices SI2,1 to SI1,K, by using thin-slice data stored in the medical image storage unit 120, that is, medical image slices SI1,1 to SI1,N. The APS unit 130 may select medical image slices corresponding to a specific index, from among the thin-slice data, as thick-slice data. For example, the APS unit 130 may select the medical image slice SI1,1 as the medical image slice SI2,1, select the medical image slice SI1,4 as the medical image slice SI2,2, and select the medical image slice SI1,7 as the medical image slice SI2,3. That is, the APS unit 130 can generate medical image slices, selected from the thin-slice data at three intervals, as thick-slice data. In some embodiments, the APS unit 130 may generate thick-slice data by performing an additional processing process on each of slices selected from thin-slice data.

The client terminal 140 of a clinical department is a terminal that is used by a clinician and configured to access, receive, and display thick-slice data stored in the medical image storage unit 120 by using a hanging protocol used in a clinical department.

If first information shared with thin-slice data is present in received thick-slice data, the client terminal 140 of the clinical department can display the received thick-slice data together with the first information. Whether or not the first information will be open can be set by a user who inputs the first information to the thin-slice data. If the first information is set to be open, the first information can be displayed in the client terminal of the clinical department. If the first information is set not to be open, the first information is not displayed on a screen of the client terminal 140.

The client terminal 150 of a radiology department or a 3-D laboratory is a terminal for generating 2-D/3-D medical image data and can be used by a radiologist. The client terminal 150 accesses, receives, and displays thin-slice data stored in the medical image storage unit 120 by using a hanging protocol that is used in a radiology department or a 3-D laboratory.

The radiologist client terminal 150 can generate 3-D data and may capture the generated 3-D data, that is, a 3-D medical image, and store the captured 3-D data in the medical image storage unit 120. The radiologist client terminal 150 may display first information in a corresponding slice of thin-slice data or store the corresponding slice of the thin-slice data together with the first information by inputting and storing the first information for the 3-D data.

Here, the radiologist can set whether the captured 3-D medical image will be open or not and whether the first information will be open or not by using a User Interface (UI) provided by the client terminal 150. When this information is stored along with the corresponding medical image, information to be used by only a specific user can be prevented from being open to the others. The radiologist can set whether at least one or more of the captured 3-D medical image, the thin-slice data, and the thick-slice will be open or not to the others.

Image data set to be not open by the radiologist is stored along with a flag (for example, ‘hide’) corresponding to ‘not-open’. Image data set to be open by the radiologist is stored along with a flag (for example, ‘show’) corresponding to ‘open’. If an unauthorized person logs in and accesses image data, a list of image data can be displayed according to a flag so that the unauthorized person is unable to know the existence of the image data that has been set to be not open.

As described above, in the system for storing and managing medical image in accordance with the present invention, thin-slice data and thick-slice data can be shared with first information, such as annotation or marking, by using coordinate information. Although thin-slice data is deleted, first information inputted by a user can be checked through thick-slice data.

Furthermore, in the present invention, the medical image storage unit 120, that is PACS, manages both the storage for storing thin-slice data and the storage for storing thick-slice data. In particular, the medical image storage unit 120 can manage the storage for storing thin-slice data according to a user. For example, the medical image storage unit 120 may manage the size of a logical or physical storage space that can be used by each user.

Thin-slice data and thick-slice data according to the present invention are sets of two types of image data that are generated from the same original image (i.e., raw image data) obtained by a medical imaging equipment or medical imaging apparatus, that is, a modality. It is evident that thick-slice data in FIG. 1 is generated from the same original image except that it is generated from thin-slice data. Furthermore, thin-slice data and thick-slice data can be selected from the same original image according to different criteria or can be reconfigured according to different reconstruction rules. A thin slice and a thick slice may be seen as medical image sets having different versions for the same original image.

In the present invention, an example in which 3-D medical image data is generated based on thin-slice data including more detailed data has been described. The contents of the present invention are not restricted by the embodiments and a numerical value, such as an interval of thin slices/thick slices.

FIG. 2 shows the configuration of an embodiment of the medical image storage unit 120 shown in FIG. 1. The medical image storage unit 120 corresponds to an apparatus for storing and managing medical image according to the present invention. The apparatus for storing and managing medical image according to the present invention is illustrated as being the PACS of FIG. 1, but is not limited to the PACS only. For example, the apparatus for storing and managing medical image according to the present invention may become a separated apparatus, such as a computing device having a client concept.

Referring to FIG. 2, the medical image storage unit 120 includes first storage means 210, second storage means 220, an access management unit 230, and a data management unit 240.

The first storage means 210 stores thin-slice data and related information, for example, thin-slice data, database (DB) of thin slices, 3-D captured images, image filtering, segmentation, and a CAD.

The first storage means 210 may receive thin-slice data from the medical imaging equipment 110 of FIG. 1 and store the received thin-slice data, but not limited thereto. The first storage means 210 may receive thin-slice data from an external input device capable of inputting the thin-slice data and store the received thin-slice data.

The second storage means 220 stores thick-slice data, generated from the same original image as thin-slice data, and related information and also stores first information stored in thin-slice data.

The second storage means 220 may store thick-slice data that is generated by using at least part of thin-slice data stored in the first storage means 210.

The second storage means 220 may receive thick-slice data from the APS unit 130 of FIG. 1 and store the received thick-slice data, but not limited thereto. For example, the second storage means 220 may receive thick-slice data from a device for capturing a medical image and store the received thick-slice data or may receive thick-slice data from an external input device capable of inputting the thick-slice data and store the received thick-slice data.

The access management unit 230 manages access to one or more of the first storage means 210 and the second storage means 220 on the basis of the role of a user who requests a medical image, that is, thin-slice data or thick-slice data.

For example, when a clinician requests a medical image, the access management unit 230 can permit access to the second storage means 220 in which thick-slice data is stored. When a radiologist requests a medical image, the access management unit 230 can permit access to the first storage means 210 in which thin-slice data is stored.

When first information is added to and stored in one medical image data (for example, thin-slice data) of the thin-slice data and thick-slice data corresponding to the thin-slice data, the data management unit 240 stores the first information in the other medical image data (for example, the thick-slice data) so that the first information can be shared.

Here, if the first information is displayed or stored in at least part slices of the thin-slice data stored in the first storage means 210, the data management unit 240 can check a second slice having information on coordinates corresponding to information on the coordinates of a first slice, from among the thick-slice data stored in the second storage means 220, by using the information on the coordinates of the first slice in which the first information is stored and can display or store the first information in the second slice so that the first information stored in the thin-slice data, together with the thick-slice data, can be shared.

Furthermore, when information on whether first information or a 3-D captured image will be open or not is received along with the first information or the 3-D captured image that is inputted by a user or received, the data management unit 240 may match the information on whether the first information or the 3-D captured image will be open or not with the first information or the 3-D captured image and store the matched information and first information or 3-D captured image in order to prevent information managed by a specific user from being provided to the others.

As described above, the apparatus for storing and managing medical image in accordance with the present invention can be applied to a case where both thin-slice data and thick-slice data are received in accordance with a variety of methods, for example, from the medical imaging equipment 110, a case where only thin-slice data is received and thick-slice data is generated by a pre-processing process, and a case where both thin-slice data and thick-slice data are received from an external input device.

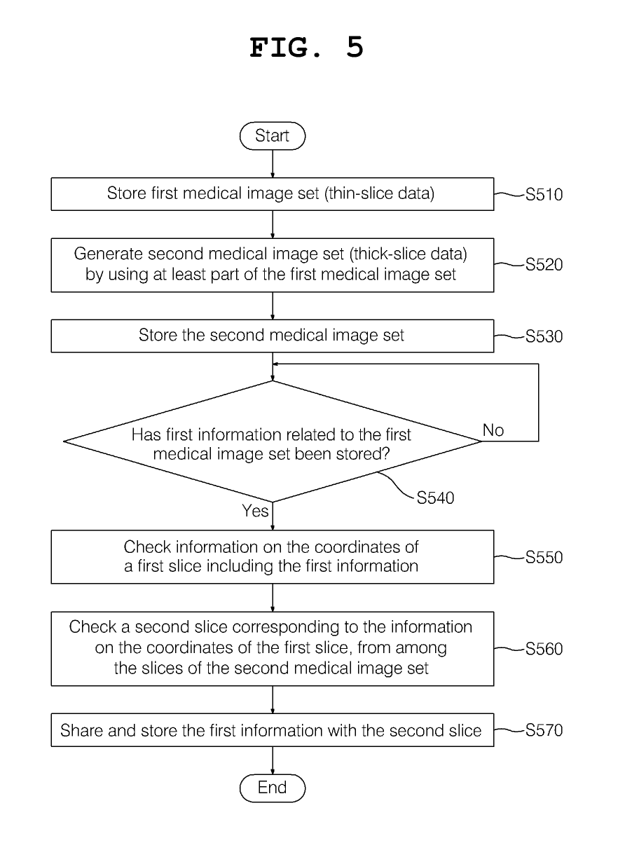

FIG. 5 is a flowchart illustrating a method of storing and managing medical image in accordance with an embodiment of the present invention. The method of FIG. 5 is performed by the medical image storage unit 120 and the APS unit 130 shown in FIG. 1.

Referring to FIG. 5, in the method of storing and managing medical image, a first medical image set corresponding to thin-slice data is stored at step S510.

The first medical image set can be generated and received from the medical imaging equipment 110 for capturing a medical image or may be received from an additional external input device for storing the first medical image set. The first medical image set is stored in the medical image storage unit 120.

A second medical image set corresponding to thick-slice data is generated using at least part of or the entire first medical image set at step S520. The second medical image set is stored in the storage that is logically or physically separated from the storage for storing the first medical image set at step S530.

The second medical image set can also be stored in the medical image storage unit 120, and the second medical image set can be generated by the APS unit 130.

Next, whether or not a user inputs first information related to the first medical image set, that is, annotation or marking, is determined at step S540. If, as a result of the determination, the first information is determined to be inputted and stored, information on the coordinates of a first slice in which the first information is displayed or stored is checked at step S550.

Here, the information on the coordinates of the first slice may be checked from the DICOM header of the first slice, may be checked using a matching table in which slices and information on coordinates are matched and stored, or may be checked using at least one method capable of checking information on coordinates.

When the information on the coordinates of the first slice is checked, a second slice corresponding to the first slice is checked from among the slices of the second medical image set corresponding to the first medical image set at step S560.

The second slice preferably is a slice having information on coordinates corresponding to information on the coordinates of the first slice. The coordinate information included in the first slice and the second slice may be information on reference coordinates that have been physically previously set in the medical imaging equipment 110 for capturing a medical image or may be information on relative coordinates corresponding to reference coordinates that have been previously set for the reference coordinate model of the human body. The reference coordinate model of the human body may include a variety of models according to a variety of criteria, and information on relative coordinates can be generated using information on reference coordinates for each model.

When the second slice of the second medical image set is checked, the first information displayed or stored in the first slice is displayed in the second slice or stored along with the second slice at step S570.

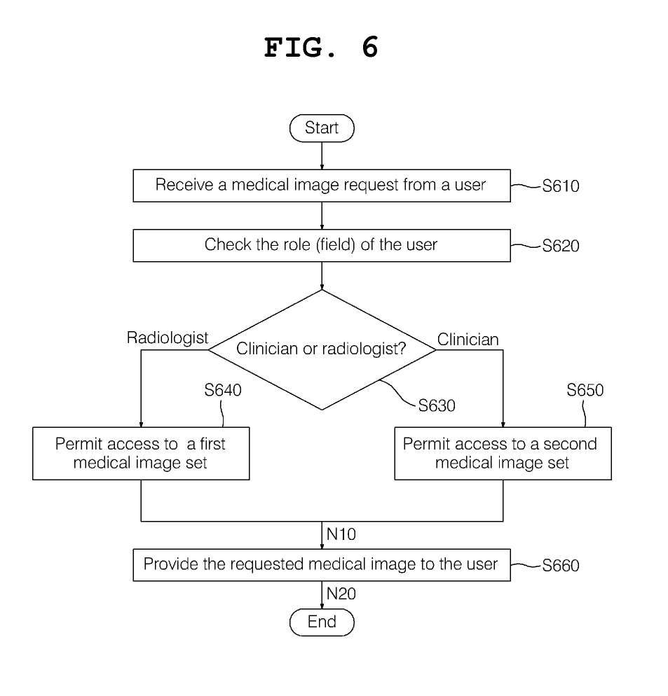

FIG. 6 is a flowchart illustrating a process of providing a medical image to a user in the method of storing and managing medical image in accordance with the present invention.

Referring to FIG. 6, a request signal that requests a medical image is received from a user, for example, a clinician or a radiologist at step S610.

The medical image request signal can be generated by PACS solution software driven in a client terminal, and the medical image request signal can include requesting medical image data, information on the user, etc.

When the medical image request signal is received, the field (or role) of the user is checked by checking the information on the user that is included in the medical image request signal at step S620.

Whether the user who has requested the medical image is a clinician or a radiologist is determined at step S630. If, as a result of the determination, the user is determined to be a radiologist, the user is permitted to access the storage for storing thin-slice data at step S640. That is, by permitting access to a first medical image set, the first medical image set requested by the user is provided to the user at step S660.

In contrast, if, as a result of the determination at step S630, the user is determined to be a clinician, the user is permitted to access the storage for storing thick-slice data at step S650. That is, by permitting access to a second medical image set, the second medical image set requested by the user is provided to the user at step S660.

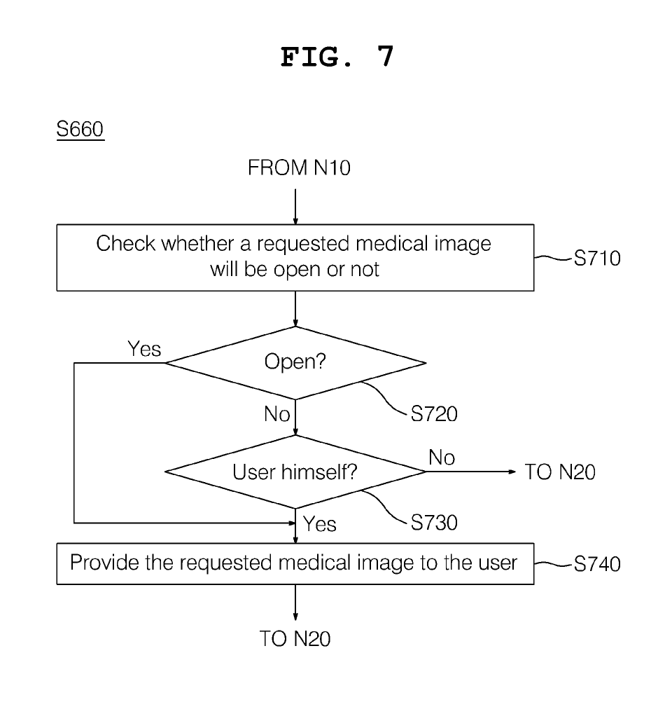

At step S660, first information stored together with the medical image requested by the user may be unconditionally provided to the user, but whether the first information will be provided or not may be determined based on information on whether the first information has been set to be open or not. If a medical image requested by a user is a 3-D captured image that has been captured and stored by a first user, whether the medical image will be provided to the user or not can be determined based on information on whether the medical image has been set to be open or not by the first user. An example in which a medical image will be provided or not based on information on whether the medical image has been set to be open or not is described below with reference to FIG. 7.

FIG. 7 is a flowchart illustrating an embodiment of the step S660 in FIG. 6. Whether a medical image will be provided or not is determined based on an item for a requested medical image, for example, a 3-D captured image which has been set to be open or not.

Referring to FIG. 7, in the step S660 of providing the medical image to the user, whether an item for the medical image requested by the user has been set to be open or not is checked at step S710.

The item for the requested medical image may be an item included in the DICOM header of the requested medical image or may be an item set in a DB in which information on the requested medical image is stored.

Whether the requested medical image will be open or not is determined by checking whether the item for the requested medical image has been set to be open or not step S720. If, as a result of the determination, the requested medical image is determined to have been set to be open, the requested medical image of the user is provided to the client terminal of the user at step S740.

In contrast, if, as a result of the determination, the requested medical image is determined to have been set not to be open, whether the user who has requested the medical image is a user, who has set whether the requested medical image will be open or not, is determined because the requested medical image has been set not to be open to other users at step S730.

Whether the user who has requested the medical image is a user who has set whether the requested medical image will be open or not may be checked by using information on the user included in a request signal when the medical image has been requested or may be checked through communication with PACS solution software that is installed in the client terminal when whether the user who has requested the medical image is a user who has set whether the requested medical image will be open or not is determined.

If, as a result of the determination at S730, the user who has requested the medical image is determined to be a user who has set whether the requested medical image will be open or not, the requested medical image is provided to the user although the requested medical image has been set not to be open, and if, as a result of the determination at S730, the user who has requested the medical image is determined not to be a user who has set whether the requested medical image will be open or not, the requested medical image is not provided to the user at step S740.

If the requested medical image has been set not to be open, the medical image may be initially set so that the medical image cannot be searched for and may be set depending on a user. For example, when a second user accesses the PACS, a 3-D captured image set not to be open by the second user, first information set not to be open by the second user, all medical images set to be open based on the role of the second user, and first information set to be open by another user can be searched for. In this case, thin-slice data or thick-slice data can be searched for, but the first information set not to be open can be checked only the user himself.

The method of storing and managing medical image in accordance with an embodiment of the present invention can be implemented in the form of a program command that can be executed by various pieces of computer means and recorded on a computer-recordable medium. The computer-readable medium can include a program command, a data file, and a data structure solely or in combination. The program command recorded on the recording medium might have been specially designed and configured for the present invention or may be known or available to a person who is skilled in computer software. Examples of the computer-readable recording medium includes a variety of hardware apparatuses that are specially configured to store and execute the program command, such as magnetic media, such as a hard disk, a floppy disk, and a magnetic tape, optical media, such as CD-ROM and a DVD, magneto-optical media, such as a floptical disk, ROM, RAM, and flash memory. Examples of the program command include a machine code, such as one written by a compiler, and a high-level language code executable by a computer by using an interpreter. The hardware apparatus can be configured in the form of one or more software modules for performing the method of the present invention, and the vice versa.

In accordance with the present invention, thin-slice data and thick-slice data are managed by the same PACS, and information on annotation or marking stored together with the thin-slice data is shared with the thick-slice data corresponding to the thin-slice data. Accordingly, there is an advantage in that the annotation or marking related to the thick-slice data can be maintained and managed by using the thick-slice data even if the thin-slice data is periodically deleted.

More particularly, in accordance with the present invention, annotation or marking can be shared between thin-slice data and thick-slice data by using previously set coordinate information. Accordingly, when annotation or marking is inputted to and stored in any one of thin-slice data and thick-slice data, for example, the first slice of the thin-slice data, the annotation or marking can also be inputted to or stored in the other of the thin-slice data and the thick-slice data, for example, a second slice corresponding to the first slice of the thick-slice data.

Furthermore, the present invention is advantageous in that two PACS do not need to be configured, system installation costs can be reduced, and thin-slice data and thick-slice data can be easily managed because the same PACS maintains and manages the thin-slice data and the thick-slice data by using pieces of logically or physically different storages in.

Although the present invention has been described in connection with the specific matters, such detailed elements, and the limited embodiments and drawings, they are provided only to help comprehensive understanding of the present invention, and the present invention is not limited to the embodiments. A person having ordinary skill in the art to which the present invention belongs may modify the embodiments in various ways from the above description.

Accordingly, the spirit of the present invention should not be construed as being limited to the embodiments, and but not only the attached claims, but also all the equivalent modifications of the claims should be constructed as belonging to the category of the present invention fall within the scope of the present invention.

1. A system for storing and managing a medical image, comprising:
a storage unit configured to:
store a first medical image set and a second medical image set, and
store first information, stored in relation to any one of the first medical image set and the second medical image set, in relation to the other of the first medical image set and the second medical image set, wherein
the second medical image set is generated by using at least part of the first medical image set.

2. The system of claim 1, wherein the storage unit is further configured to share the first information between the first medical image set and the second medical image set by using information on coordinates of each of first slices included in the first medical image set and information on coordinates of each of second slices included in the second medical image set.

3. The system of claim 2, wherein:
each of the first slices and the second slices comprises information on reference coordinates previously set in a medical imaging equipment for capturing an original image of the first medical image set, and
the storage unit is further configured to share the first information by using information on the reference coordinates included in each of the first slices and the second slices.

4. The system of claim 2, wherein:
each of the first slices and the second slices comprises information on relative coordinates corresponding to reference coordinates previously set in relation to a human body, and
the storage unit is further configured to share the first information by using information on the relative coordinates included in each of the first slices and the second slices.

5. The system of claim 1, further comprising a processor, wherein:
the storage unit further comprises:
a first storage unit configured to store the first medical image set and
a second storage unit configured to store the second medical image set, and
the processor is configured to permit access to at least one of the first storage unit and the second storage unit based on a role of a user who requests a medical image.

6. The system of claim 1, wherein the storage unit is further configured to determine whether the first information will be open or not based on a setting of a user who inputs the first information.

7. The system of claim 1, wherein the storage unit is further configured to determine whether a third medical image set generated using the first medical image set or the second medical image set, the first medical image set, or the second medical image will be open or not based on a setting of a user.

8. A system for storing and managing a medical image, comprising:
a storage unit configured to store a first medical image set; and a second medical image set generated from an original image set identical to the first medical image set; and
a processor configured to:
share and relate first information between the first medical image set and the second medical image set, stored in relation to one of the first medical image set and the second medical image set, and
store, in the storage unit, the first information in relation to the other of the first medical image set and the second medical image set.

9. The system of claim 8, wherein the second medical image set is generated by using at least part of the stored first medical image set.

10. The system of claim 8, wherein the processor is further configured to manage access to at least one of the first medical image set and the second medical image set based on a role of a user who requests the medical image.

11. A method of storing and managing a medical image, comprising:
storing, at a storage unit, a first medical image set;
storing, at the storage unit, a second medical image set which is generated by using at least part of the stored first medical image set; and
storing, at the storage unit, first information, stored in relation to one of the first medical image set and the second medical image set, in relation to the other of the first medical image set and the second medical image set.

12. The method of claim 11, wherein the storing of the first information further comprises sharing and relating the first information between the first medical image set and the second medical image set by using information on coordinates of each of first slices included in the first medical image set and information on coordinates of each of second slices included in the second medical image set.

13. The method of claim 12, wherein the sharing and relating of the first information further comprises sharing and relating the first information by using information on reference coordinates included in each of the first slices and the second slices and previously set in a medical imaging equipment for capturing an original image of the first medical image set.

14. The method of claim 11, further comprising controlling, by a processor, access to at least one of the first medical image set and the second medical image set based on a role of a user who requests the medical image.

15. A non-transitory computer-readable medium containing program instructions that are executable by a processor and that store a program for executing a method of storing and managing a medical image, the non-transitory computer-readable medium comprising:
program instructions that store a first medical image set;
program instructions that store a second medical image set which is generated by using at least part of the stored first medical image set; and
program instructions that store first information, stored in relation to one of the first medical image set and the second medical image set, in relation to the other of the first medical image set and the second medical image set.
